(19) United States
(12) Patent Application Publication
(10) Pub. No.: US 2016/0188855 A1
(43) Pub. Date: Jun. 30, 2016

(54) Secure PIN Entry

(71) Applicants: Michael Ara Bezjian, Coral Gables, FL (US); Michelle Ani Bezjian, New York, NY (US); Alexander Rockwell Bezjian, Yerevan (AM)

(72) Inventors: Michael Ara Bezjian, Coral Gables, FL (US); Michelle Ani Bezjian, New York, NY (US); Alexander Rockwell Bezjian, Yerevan (AM)

(21) Appl. No.: 14/583,301

(22) Filed: Dec. 26, 2014

(51) Int. Cl. G06F 21/31; G06F 21/32

(52) U.S. Cl. CPC G06F 21/316; G06F 21/32

(57) ABSTRACT

In this invention, with the use of TouchTime, TimeGap, Repetitive TimeGap, Pressure Sensitivity, Fingerprint Detection and Position methods, the authorized persons ensure a secure entry of their PIN codes into keypads. These methods using accordingly the time that the keys are kept depressed, the wait time between pressing the keys and between inserting the keys repetitively, and the pressure of entry of the keys, enhance the security of their PIN numbers as they increase the level of difficulty for non-authorized persons to see and understand how each key was pressed or entered. The Fingerprint Detection method ensures the authentication of the authorized person's fingerprints based on fingerprint detectors. As for the Position method, there are locations used for pressing the buttons and the described five methods are being applied while performing the PIN Entry.

### RELATED APPLICATIONS

This application claims the benefit of U.S. Provisional Application Ser. No. 61/922,276, filed on Dec. 29, 2013 and entitled SECURE PIN ENTRY, the contents of which are expressly incorporated herein by reference.

### BACKGROUND OF THE INVENTION

The present invention is in the technical field of security. More particularly, this invention relates to the technical field of PIN (Personal Identification Number) entry into alphanumeric keypads, or keyboard keypads, or touch screen driven and other similar character entry pads or buttons for pressing or touching. Within the scope of this invention, the PIN can be composed of digital and alphanumeric characters and symbols and any other characters that can be pressed. Furthermore, a PIN can also be buttons or areas on the entry pad with no characters, but have locations such as top bottom left or right buttons.

As security has become a great concern, security keypads are often used to enable a secure entry into physical doors and spaces, or entering electronically into online areas and browsing on the internet. In addition, to use credit cards, access bank accounts, pay with credit cards on POS (Point of Sale) terminals, and other such devices often require the user to enter his or her PIN code into the number keypad or the keyboard or some display of some sort where the user applies his/her PIN code.

All such events bear the danger that a bystander or someone viewing who are considered non-authorized persons or even security cameras may see the PIN entered. This can later be used by other people for unauthorized entry.

There are some practices today that try to enhance the security of the PIN being entered. POS terminals come with side guides that block viewers from the side to see the actual buttons the operator is pressing. Or the PIN entry pad or section is placed deep inside a structure so to reduce the chances that another person may see the buttons pressed. These are usually mechanical systems or view-blocking devices and can be fixed or movable.

Nevertheless, if the non-authorized person managed to see the buttons entered, then the side or such protective guides are useless.

In addition, there is an ATM safety PIN software system that has been patented. U.S. Pat. No. 5,731,575 filed in USPTO. It is intended to alert the police when the PIN is entered in reverse order. The purpose of such a patent, comprised of software and the PIN keypad and related accessories, is to alert the police for forced cash withdrawals, and sometimes referred to as Duress codes. These serve a different purpose and are not created to protect the authorized person from non-authorized persons who see the PIN buttons pressed.

### SUMMARY OF THE INVENTION

This invention is a method by which the authorized person entering the PIN can use several new security methods in addition to the method of numbers and characters being entered in. This makes it more secure and reduces the chances of others gaining unauthorized access. The additional methods include: (i) TouchTime method, (ii) TimeGap method, (iii) Repetitive TimeGap method, (iv) Pressure Sensitivity method, (v) Fingerprint Detection method, and (vi) Position method.
(i) TouchTime method relates to enabling the authorized person to enter his/her PIN buttons using the time they are kept depressed as an additional authentication method. In this case, if the time duration the key is pressed and kept pressed down does not match the proper time configured or programmed previously, the PIN entry will be rejected.
(ii) TimeGap method is another method for the PIN authentication which allows authorized persons to increase the security level of their PIN codes by defining the wait time between pressing the keys. Consequently, the PIN entry will be rejected if the numbers are pressed with wait times that do not match the proper time configured or programmed previously.
(iii) Repetitive TimeGap method relates to the method of entering the PIN characters twice enabling the authorized person to apply the TimeGap between entering the same character for the second time. If the wait time between pressing the characters repetitively does not match the proper time configured or programmed previously, the PIN entry will be rejected.
(iv) Pressure Sensitivity method relates to the pressure with which the authorized person is pressing the keys in order to enter his/her PIN numbers. Based on this, the PIN entry will be rejected if the key is not pressed according to the proper pressure levels configured or programmed previously.
(v) Fingerprint Detection method relates to the method of comparing the fingerprints of the authorized person entering his/her PIN to the stored fingerprint version. If the fingerprints do not match the proper fingerprints stored on the database, the PIN entry will be rejected.
(vi) Position method relates to the method of pressing buttons sequence based on the different positions of each button using the methods (i)-(v).

### BRIEF DESCRIPTION OF THE DRAWINGS

FIG. 1 shows a system composed of PIN entry devices connected to the database stored in the cloud.

FIG. 2 shows a system composed of PIN entry devices connected to the database stored on local servers.

FIG. 3 shows a flowchart depicting a PIN verification process.

FIG. 4 shows a PIN entry verification system performed locally on a smartphone or smart device.

FIG. 5 shows an illustrative example of TouchTime method.

FIG. 6 shows an illustrative example of TimeGap and Repetitive TimeGap methods.

FIG. 7 shows an illustrative example of Pressure Sensitivity method.

FIG. 8 shows a flowchart depicting the Fingerprint Detection method.

FIG. 9 shows an illustrative example of Position method.

### DETAILED DESCRIPTION OF THE INVENTION

This invention refers to PIN entry by authorized persons, wherein authorized person is defined as someone who has been given or selected the PIN sequence with the security attributes for each key, or who has been given or selected the PIN sequence and then has personally assigned the security attributes for each key, whereas the non-authorized persons are all the others who this invention creates a protection against and who might see the PIN characters being entered and attempt to gain unauthorized access and perform transactions that only authorized persons are given rights to perform.

The methods by which the authorized person acquires PIN and attributes are:

1) Initially a secure server input program issues the PIN sequence to the authorized person, and next to each character it also identifies the attribute to be used with that character.

2) The PIN is given to the authorized person, then the person using a software program enters each character then assigns his/her preferred attribute for that character. In either case, once these processes are done, the authorized person ends up having a PIN sequence with the security attributes for each key. This is what he/she must use in the future.

The present invention is a method, comprising of software and keypad or keyboard, that enable the authorized person to conduct a secure PIN entry with the use of TouchTime, TimeGap, Repetitive TimeGap, Pressure Sensitivity and Fingerprint Detection methods. The latter use respectively the following attributes: TouchTime, TimeGap, Repetitive TimeGap, Pressure Sensitivity, and Fingerprint Detection method. Thus, the authorized person may enter the same PIN keys, or press the same PIN buttons using additional attributes for each key pressed.

Using such attributes increases significantly the difficulty level for non-authorized persons to see and understand and decode the PIN entry methods. They might see and remember the keys pressed, but not remember or understand the underlying secret methods of how such keys were pressed or entered.

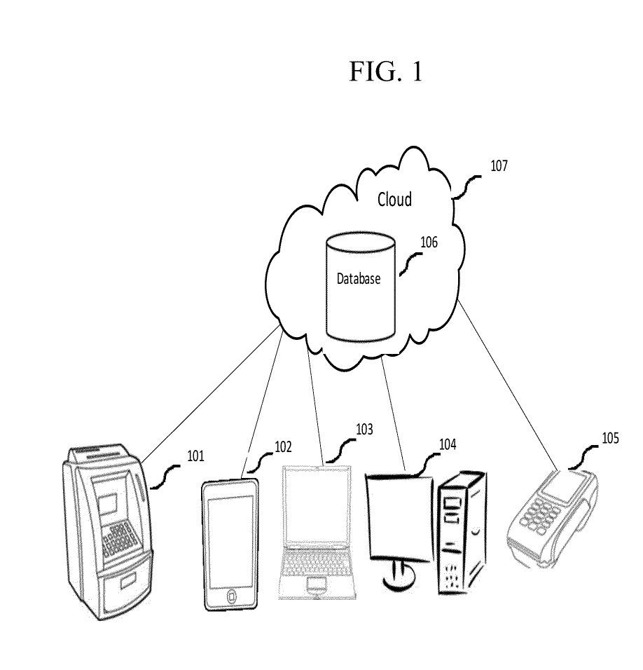

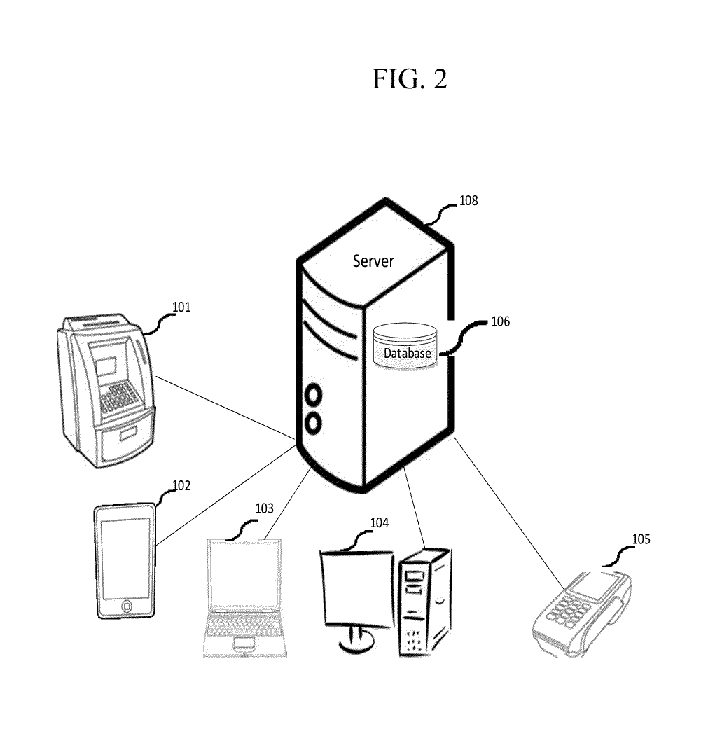

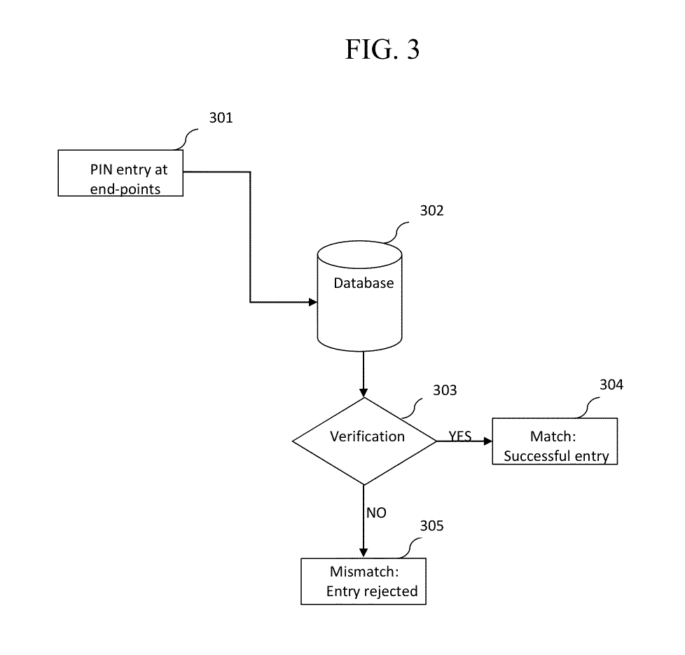

The PIN entry is shown in FIG. 1. It can be performed using entry devices like ATM machine 101, smartphone 102, PC 103, laptop 104, and POS terminal 105 called end-point devices that are connected to the database 106 stored in the cloud 107 or on local servers 108 (FIG. 2). Thus, PIN characters and attributes are kept on secure encrypted environment, and the combinations of inserted PIN characters and attributes are being verified as shown in FIG. 3. First, the authorized person performs the PIN entry 301 at end-point. Afterwards, the data is sent as a query to database 302 where it is compared to the stored data. For all five methods, both the PIN characters and additional attributes go through a verification 303. If they match the data, the PIN entry is successful (304), otherwise if there is a mismatch, the PIN entry is rejected (305).

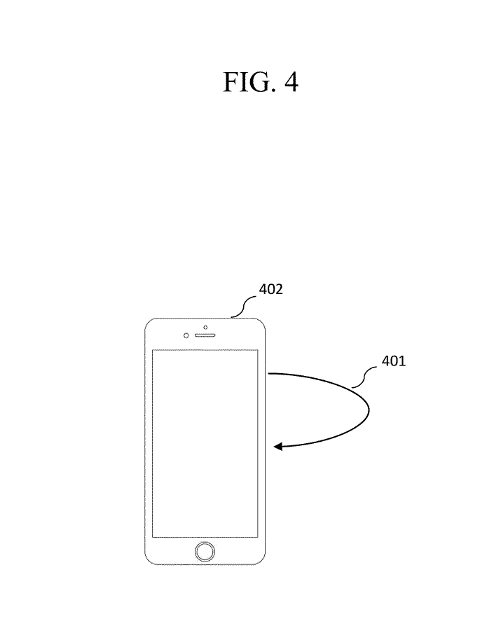

For devices intended for personal use, such as smartphones, the PIN verification can also be done locally. The authorized person enters the PIN characters with additional attributes that are stored on the database which is stored in the smartphone itself, and they are being verified comparing with the stored information. FIG. 4 shows the verification process 401 performed locally within the smartphone 402.

### TouchTime Method

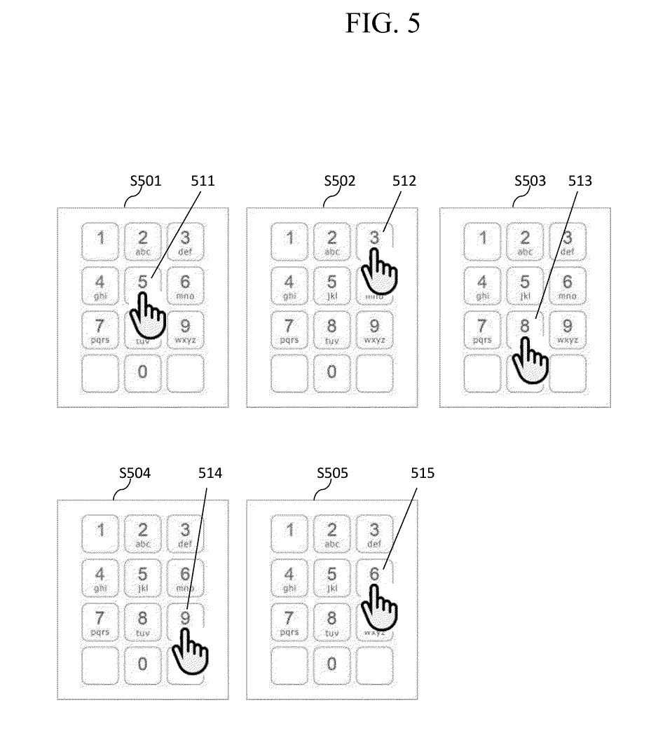

In the case of TouchTime method if a key is pressed and kept depressed for 1 second long duration then released, would be one type of entry of the same button, yet the same key pressed and kept depressed for 3 seconds long duration then released, would be treated as another type of entry. This TouchTime attribute can have several durations. A simple system may have only two TouchTimes, short and long. For example, in FIG. 5 the 3 button 512 when pressed quickly and released within a short duration, example under 1 second, will be considered Short 3 Entry. This will be identified differently in the case when the same 3 button 3 is pressed and kept pressed down for longer than 1 second, such as for a 3 or 4 second duration. This will be considered Long 3 Entry.

In this case the time-based attributes are considered a second security attribute for the secure entry of the PINs. The first attribute is the actual characters being entered or pressed, and the second attribute is the time durations of the keys pressed.

The description presented in the first paragraph of this section depicts the TouchTime attribute having two possibilities, Short and Long. In a further embodiment of this invention, the TouchTime method can consist of three TouchTime attributes. These can be grouped as Short, Medium and Long. A Short TouchTime can be defined as under 0.5 seconds, a Medium TouchTime can be defined as between 0.5 to 2 seconds, and a Long can be defined as over 2 seconds. In all cases, each key can have three TouchTime attributes. For the example of pressing the 5 key 511 in FIG. 5, it can be a Short 5, Medium 5 and Long 5.

The following more specific example depicts an authorized person who will enter the PIN code 53896 into the PIN Pad where there are two TouchTime attributes for each number, Short and Long. Short is defined as under 1 second long TouchTime, and Long is defined as above 1 second TouchTime.

In the example, the authorized person has already selected these TouchTimes while creating the PIN entry in the system, and where the PIN numbers 5, 8 and 9 are set to be Short, and the 3 and 6 are set to be Long.

Referring to FIG. 5, to enter this PIN code 53896 correctly into the keypad, the authorized person will use the following attributes, listed in the Table 1 below while entering the PIN code.

TABLE 1

| PIN Code | |
|---|---|
| character | TouchTime attribute |
| 5 | Short <1 second |
| 3 | Long = or >1 second |
| 8 | Short <1 second |
| 9 | Short <1 second |
| 6 | Long = or >1 second |

Referring to FIG. 5, the authorized person will:

First, at step S501 press on the 5 key button 511 and keep it pressed down a short instance under 1 second long.

Then, at step S502 the person will press on the 3 key button 512 and keep it pressed down for two seconds or more.

Then, at step S503 the person will press on the 8 key button 513 and keep it pressed down for a short instance under 1 second.

Then, at step S504 the person will press on the 9 key button 514 and keep it pressed down for a short instance under 1 second.

Then, at step S505 the person will press on the 6 key button 515 and keep it pressed down for two seconds or more.

This will complete a successful entry of the PIN code.

However, if the authorized person entered the correct PIN code characters, but during any one of the entries he/she used the wrong TouchTime attribute, then the PIN code entry will be considered wrong, and the person may be asked to retry. For example, in the previous example, if he/she at step S505 entered the 6 key button 515 and instead of keeping the key pressed down for 2 seconds or more (Long), the authorized person keeps the key pressed down for less than 1 second making it a Short 6 key entry. This would not be a correct PIN code entry and therefore approval or access will be denied.

In the case of TouchTime method, when the authorized person clicks on the button and keeps it pressed for some time, there is an underlying software that detects the number that is being inserted and measures the length of time that the key is pressed down. That program transmits the information to the server where the decision is being made. The data is being compared to the stored information on database and the additional software is verifying it. If it matches the stored data, then the entry is successful; if there is a mismatch, the signal goes back with a rejection message.

In fact the attaching additional attributes to each character of the PIN not only reduces non-authorized persons from remembering how to enter the same PIN, but it also significantly increases the number of probable entries. For example, simple 2 character PIN, where each character can only be a number of 0 to 9, as in FIG. 5, can have 100 possible permutations. When another attribute such as the TouchTime attribute with 2 possible variations, Short and Long are added to the two digit PIN, the number of possibilities increases to 400. Therefore, one of the benefits of this invention is that with shorter PIN codes, a larger number of permutations can be achieved, hence making it easier for authorized person to remember the PIN code, yet harder for non-authorized person to see and steal it.

### TimeGap Method

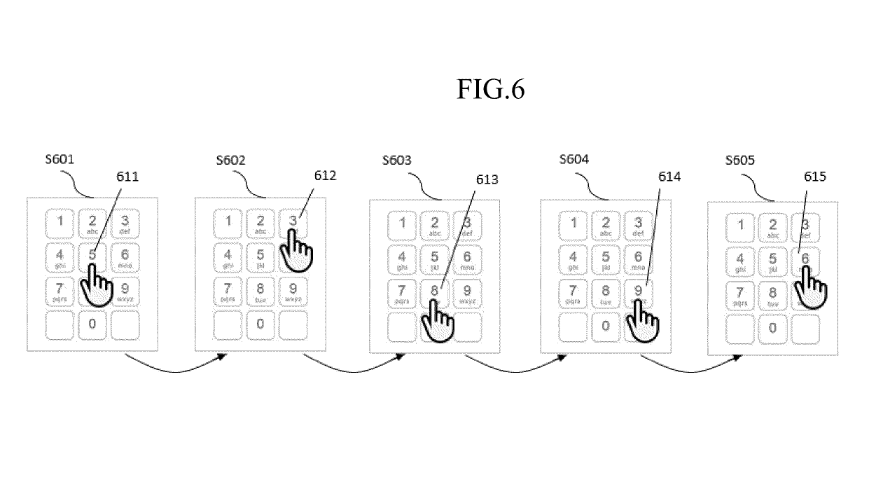

Another method using time as an additional security method is the TimeGap method. It uses the TimeGap attribute which, in its turn, is defined as the wait time between pressing the keys. For example, in FIG. 6, when the two keys 5 and 3 are entered, the authorized person may press the 5 button 611 then release it, and then soon after within no later than half a second press the 3 key button 612. This would be considered one type of entry for the same button whereas in the case where the person waited some time in between entering or pressing these two keys, it would be considered another type of entry. For example, the person may press the 5 key 611 and release it, wait 3 seconds without entering or pressing any other key, then enter or press the 3 key 612.

In a further embodiment of this invention, the TimeGap method can consist of three TimeGap attributes. These can be grouped as Short, Medium and Long. A Short TimeGap can be defined as under 0.5 seconds, a Medium TimeGap can be defined as between 0.5 to 2 seconds, and a Long can be defined as over 2 seconds.

Using the previous example that depicts an authorized person who will enter the PIN code 53896 into the PIN Pad where there are two TimeGap attributes for each entry, Short and Long, Short being the wait time between pressing the keys defined no longer than 3 seconds, and Long defined as above 3 seconds TimeGap.

In this example, the authorized person has already selected the TimeGaps while creating the PIN Entry in the system, and where the wait time between entering the PIN numbers 5 and 3, and between the PIN numbers 8 and 9 are set to be Long, while the wait time between entering the PIN numbers 3 and 8, and 9 and 6 is set to be Short.

Referring to FIG. 6, to enter this PIN code 53896 correctly into the keypad, the authorized person will use the following attributes, listed in the Table 2 below, while entering the PIN code,

TABLE 2

| Sequential PIN | |
|---|---|
| Characters | TimeGap attribute |
| 5, 3 | Long = or >3 second |
| 3, 8 | Short <3 second |
| 8, 9 | Long = or >3 second |
| 9, 6 | Short <3 second |

Referring to FIG. 6, the authorized person will:

First, at step S601 press on the 5 key button 611 and wait 3 seconds or more before pressing on the 3 key button 612.

Then, at step S602 the person will press on the 3 key button 612 and wait no longer than 3 seconds before pressing on the 8 key button 613.

Then, at step S603 the person will press on the 8 key button 613 and wait 3 seconds or more before pressing on the 9 key button 614.

Then, at step S604 the person will press on the 9 key button 614 and wait no longer than 3 seconds before pressing on the 6 key button 615.

Then, at step S605 the person will press on the 6 key button 615.

This will complete a successful entry of the PIN code.

However, if the authorized person entered the correct PIN characters, but between pressing any two of them, he/she used the wrong TimeGap attribute, then the PIN code entry will be considered wrong, and the person will be asked to retry. For example, if at step S603 the authorized person entered the 8 key button 613 and instead of waiting 3 seconds or more (Long), he/she waits less than 3 seconds before pressing on the 9 key button 614 at step S604 making it a Short TimeGap entry between those 2 keys, would not be a correct PIN code entry and therefore approval or access will be denied.

In the case of TimeGap method, when the authorized person clicks on the button and waits some time before clicking the next button, there is an underlying software that detects the number that is being inserted and measures the length of time the authorized person waits before clicking the next button. That program transmits the information to the server where the decision is being made. The data is being compared to the stored information on database and the additional software is verifying it. If it matches the stored data, then the entry is successful; if there is a mismatch, the signal goes back with a rejection message.

### Repetitive TimeGap Method

The Repetitive TimeGap method uses another attribute, the Repetitive TimeGap attribute, which is defined as the wait time between pressing the second repetitive character.

In a further embodiment of this invention, the Repetitive TimeGap method can consist of three TimeGap attributes. These can be grouped as Short, Medium and Long. A Short TimeGap can be defined as under 0.5 seconds, a Medium TimeGap can be defined as between 0.5 to 2 seconds, and a Long can be defined as over 2 seconds.

Using the same example as for the previous attributes, which depicts an authorized person who will enter the PIN code 53896 into the PIN Pad where there are two Repetitive TimeGap attributes for each entry, Short and Long, Short being the wait time between pressing the two repetitive characters defined no longer than 3 seconds, and Long defined as above 3 seconds TimeGap.

In this example, the authorized person has already selected the Repetitive TimeGaps while creating the PIN Entry into the system, and where the wait time between entering the Repetitive PIN number 5 (entering the character 5 twice), and Repetitive PIN numbers 8 and 9 are set to be Long, while the wait time between entering the Repetitive PIN numbers 3 and 6, and 9 and 6 is set to be Short.

Referring to FIG. 6, to enter this PIN code 53896 correctly into the keypad, the authorized person will use the following attributes, listed in the Table 3 below, while entering the PIN code,

TABLE 3

| PIN Code | Repetitive TimeGap |
|---|---|
| character | attribute |
| 5 (5) | Long = or >3 second |
| 3 (3) | Short <3 second |
| 8 (8) | Long = or >3 second |
| 9 (9) | Long = or >3 second |
| 6 (6) | Short <3 second |

Referring to FIG. 6, the authorized person will:

First, at step S601 press on the 5 key button 611 and wait 3 seconds or more before pressing it again.

Then, at step S602 the person will press on the 3 key button 612 and wait no longer than 3 seconds before pressing it for the second time.

Then, at step S603 the person will press on the 8 key button 613 and wait 3 seconds or more before pressing it again.

Then, at step S604 the person will press on the 9 key button 614 and wait 3 seconds or more before pressing it again.

Then, at step S605 the person will press on the 6 key button 615 and wait no longer than 3 seconds before pressing it for the second time.

This will complete a successful entry of the PIN code.

However, if the authorized person entered the correct PIN code characters, but between repetitively pressing any of them, he/she used the wrong TimeGap attribute, then the PIN code entry will be considered wrong, and the authorized person will be asked to retry. For example, if at step S603 the authorized person entered the 8 key button 613 and instead of waiting 3 seconds or more (Long), he/she waits less than 3 seconds before pressing it again making it a Short TimeGap entry between the repetitive entry of that key, would not be a correct PIN code entry and therefore approval or access will be denied.

In the case of Repetitive TimeGap method, when the authorized person clicks on the button and waits some time before clicking it repetitively, there is an underlying software that detects the number that is being inserted and measures the length of time the authorized person waits before clicking the repetitive button for the second time. That program transmits the information to the server where the decision is being made. The data is being compared to the stored information on database and the additional software is verifying it. If it matches the stored data, then the entry is successful; if there is a mismatch, the signal goes back with a rejection message.

In another embodiment of this invention, the Repetitive TimeGap attribute is assigned to any number of the PIN keys. For instance, for the PIN code 53896 described above only the PIN characters 8 and 6 will be inserted with Repetitive TimeGap attribute (Long e.g.), meaning that the authorized person will press on the 8 key button 613 and wait for more than 3 seconds before reentering the same character, and proceed in the same way with the 6 key button 614. As for the rest of the PIN characters (5 key button 611, 3 key button 612, and 9 key button 614), they will be entered normally without any attribute.

### Pressure Sensitivity Method

In another embodiment of this invention, Pressure Sensitivity attributes are used. This refers to the fact that the Pressure with which the authorized person presses the keys down is detected by the hardware or the keypad buttons and its underlying software application.

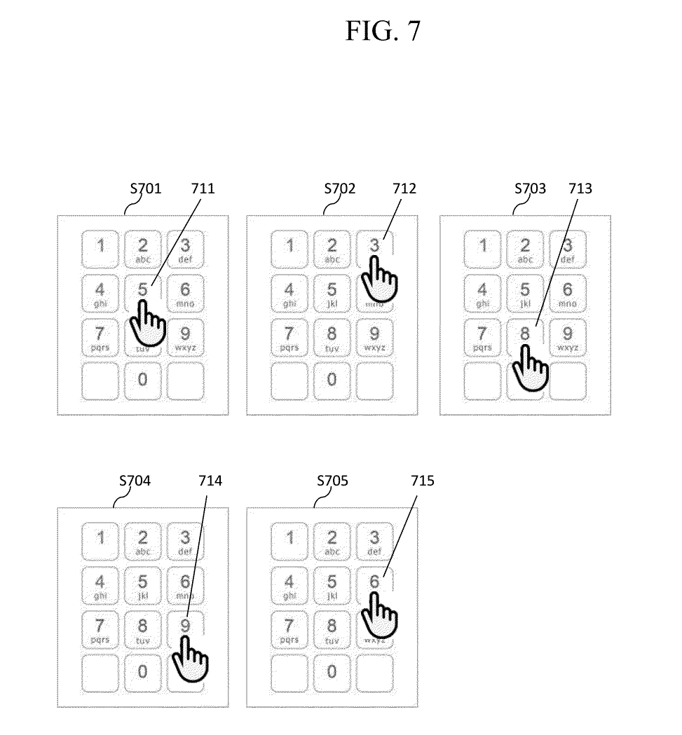

The above description depicts the Pressure Sensitivity attribute having two possibilities, High Pressure Touch and Low Pressure Touch. In the case of the High Pressure Touch, the authorized person entering or pressing on the touch pad's 5 key, presses the 5 key 711 in FIG. 7 and depresses it with force. In the case of the Low Pressure Touch, the person presses the key and depresses it lightly. In other words the 5 key 711 can also be either a High Pressure Touch 5 key, or a Low Pressure Touch 5 key.

In other embodiments of this invention, more than two levels of Pressure Sensitivity attributes may be used, such as High Pressure, Medium Pressure, and Low Pressure, accompanied by more complex underlying software and more sensitive touch pads and keys.

The example depicts an authorized person who will enter the PIN code 53896 into the PIN Pad. Where there are two Pressure Sensitivity attributes for each number. High or Low. High is defined as above 0.2 PSI. Low is defined as lower than 0.2 PSI. These Pressure attributes can be different for different PIN pads, or different appliances, or terminal systems.

In this example, the authorized person has already selected these pressure measures while creating the PIN entry in the system, and where the PIN numbers 5, 8 and 9 are set to be High, and 3 and 6 are set to be Low.

Referring to FIG. 7, to enter this PIN code 53896 correctly into the keypad, the authorized person will use the following attributes, listed in the Table 4 below, while entering the PIN code.

TABLE 4

| PIN Code | Pressure Sensitivity |
|---|---|
| character | attribute |
| 5 | High >0.2 PSI |
| 3 | Low = or <0.2 PSI |
| 8 | High >0.2 PSI |
| 9 | High >0.2 PSI |
| 6 | Low = or <0.2 PSI |

Referring to FIG. 7, the authorized person will:

First, at step S701 press on the 5 key button 711 and press it hard. Then, at step S702 the person will press on the 3 key button 712 and press it lightly.

Then, at step S703 the person will press on the 8 key button 713 and press it hard. Then, at step S704 the person will press on the 9 key button 714 and press it hard. Then, at step S705 the person will press on the 6 key button 715 and press it lightly.

This will complete a successful entry of the PIN code.

However, if the authorized person entered the correct PIN code characters, but on any one of the entries used the wrong Pressure, then the PIN code entry will be considered wrong, and he/she will be asked to retry. For example, if at step S705 the authorized person entered the 6 key button 715 and instead of pressing lightly, he/she pressed hard implying High Pressure, this would not be a correct PIN code entry and therefore approval or access will be denied.

In the case of Pressure Sensitivity method, when the authorized person clicks on the button and keeps it pressed with some level of pressure, there is an underlying software that detects the number that is being inserted and measures the level of pressure with which the key is pressed down. That program transmits the information to the server where the decision is being made. The data is being compared to the stored information on database and the additional software is verifying it. If it matches the stored data, then the entry is successful; if there is a mismatch, the signal goes back with a rejection message.

In a further embodiment of this invention, the pressure measure is not preprogrammed as an absolute value, such as greater than or less than 0.2 PSI (or other amounts). The underlying software and the touch pad keys and buttons have a more sophisticated design that detect the operator's pressure measures of keys in relation to each other in the same session.

For example, during the five-digit entry, the system would detect which keys are pressed harder than the rest, and therefore automatically dividing the PIN entry session into high and low groups. This embodiment is very useful in managing situations where the authorized person entering the PIN code has large fingers or is a more heavy set person and thus unable to operate the PIN code entries within the accurate pressure limits. In such a case the relative pressures used between each key entry of the same PIN entry session are used and analyzed by the underlying software, and accordingly accept or reject the PIN entry.

### Fingerprint Detection Method

In another embodiment of this patent, each key or button of the pad detects fingerprints of the authorized person. This is especially true with touch screens which are becoming more widespread in their use. Such examples include touch screen phones, tablets, PC monitors, touch screen car or machine interfaces. Such a system is comprised of the touch finger print detectors built into the keypad or the touch screen where the keypad is displayed. It utilizes an underlying intelligent software application that reads the fingerprint image and compares it with fingerprint images in its database for authentication. If it matches the stored information, the PIN entry is successful; if there is a mismatch, the signal goes back with a rejection message.

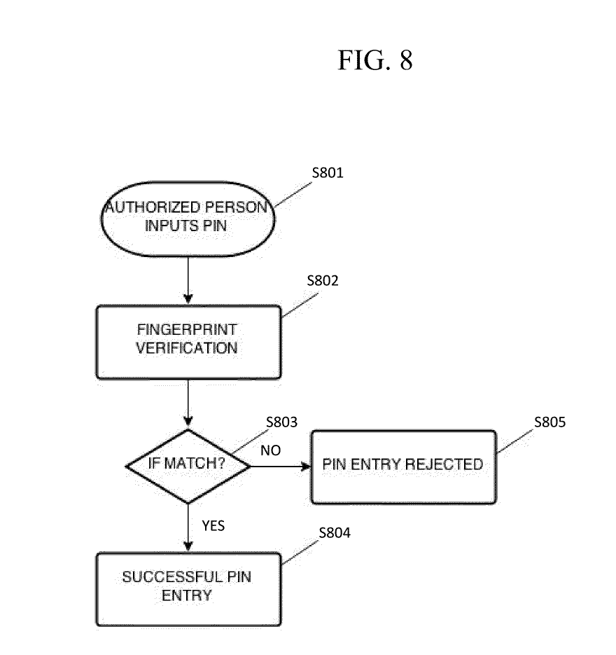

FIG. 8 shows an illustrative example for PIN entry using Fingerprint Detection method. At step S801 the authorized person inputs the PIN number at end-point. The end-point devices have fingerprint readers under the buttons or keys that are connected to the fingerprint database. After the person inserts the PIN, the fingerprints are being verified at step S802 with the database of the stored fingerprints. At step S803, if they match the stored fingerprint of the authorized person, then the entry is successful at step S804. Otherwise it is rejected at step S805. This system is extremely effective, as it combines a series of PIN characters entered with a unique biometric (fingerprint) detection of the authorized person.

### Position Method

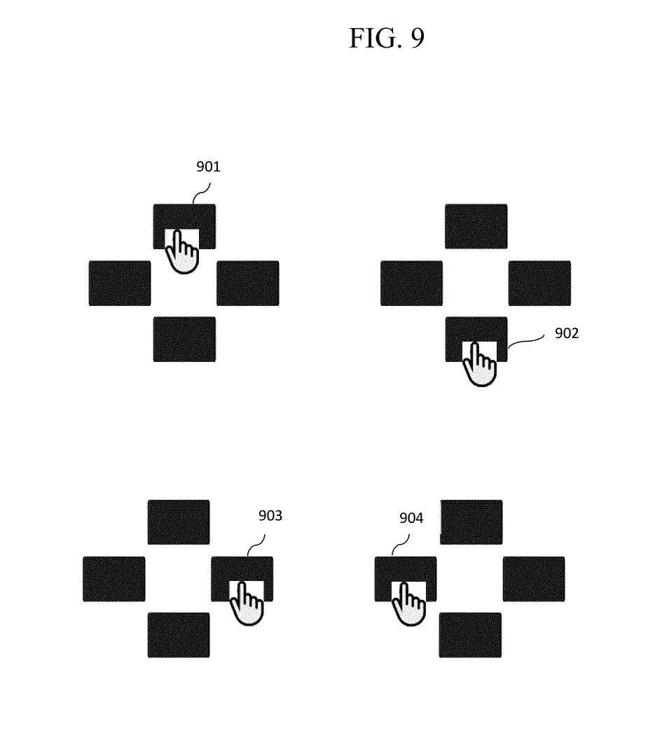

In another embodiment of this patent, the Position method is used. It consists in entering the PIN code by pressing the buttons that do not have characters on them, but instead have locations shown in FIG. 9 (top button 901, bottom button 902, right button 903, and left button 904). In a further embodiment of this invention, any number of locations can be used to create PIN entry buttons. In the case of Position method, the PIN entry is performed by using also the TouchTime, TimeGap, Repeptitive TimeGap, Pressure Sensitivity or Fingerprint Detection methods.

In the case of Position method, when the authorized person clicks on the buttons and applies one of the mentioned attributes, there is an underlying software that detects the location that is being pressed and measures the attribute used while pressing on that location. That program transmits the information to the server where the decision is being made. The data is being compared to the stored information on database and the additional software is verifying it. If it matches the stored data, then the entry is successful; if there is a mismatch, the signal goes back with a rejection message.

What is claimed is:

1. A method for performing secure PIN entry wherein the PIN characters are inserted using TouchTime method, comprising touching the buttons and keeping them touched for a duration of time which is programmed or configured beforehand.

2. A method as based on claim 1 wherein the PIN entry is performed pressing the buttons and keeping them pressed down for a duration of time which is programmed or configured beforehand.

3. A method for performing secure PIN entry wherein the PIN characters are inserted using TimeGap method, comprising touching the buttons and waiting a duration of time before touching the next character in PIN sequence, the duration of time being programmed or configured beforehand.

4. A method as based on claim 3 wherein the PIN entry is performed by pressing the buttons and waiting a duration of time before pressing the next character in PIN sequence, the duration of time being programmed or configured beforehand.

5. A method for performing secure PIN entry wherein the PIN characters are inserted using Repetitive TimeGap method, comprising touching the buttons and waiting a duration of time before touching the repetitive character's button, the duration of time being programmed or configured beforehand.

6. A method as based on claim 5 wherein the PIN entry is performed by pressing the buttons and waiting a duration of time before pressing the repetitive character's button, the duration of time being programmed or configured beforehand.

7. A method for performing secure PIN entry wherein the PIN characters are inserted using Pressure Sensitivity method, comprising touching the buttons with a pressure level which is programmed or configured beforehand.

8. A method as based on claim 7 wherein the PIN entry is performed by pressing the buttons with a pressure level which is programmed or configured beforehand.

9. A method for performing secure PIN entry wherein the PIN characters are inserted using Fingerprint Detection method, comprising inserting the PIN characters wherein the fingerprints of the person entering the PIN are being verified with the help of underlying software application that compares them to the database of stored fingerprints.

10. A method for performing secure PIN entry wherein the PIN is inserted using Position method comprising touching or pressing the locations.

11. A method as based on claim 10 wherein the locations are touched or pressed using TouchTime method, comprising touching or pressing the locations and keeping them touched or pressed for a duration of time which is programmed or configured beforehand.

12. A method as based on claim 10 wherein the locations are touched or pressed using TimeGap method, comprising touching or pressing the locations and waiting a duration of time before touching or pressing the next location in PIN sequence, the duration of time being programmed or configured beforehand.

13. A method as based on claim 10 wherein the locations are touched or pressed using Repetitive TimeGap method, comprising touching or pressing the locations and waiting a duration of time before touching or pressing the repetitive location, the duration of time being programmed or configured beforehand.

14. A method as based on claim 10 wherein the locations are touched or pressed using Pressure Sensitivity method, comprising touching or pressing the locations with a pressure level which is programmed or configured beforehand.

15. A method as based on claim 10 wherein the locations are touched or pressed using Fingerprint Detection method, comprising inserting the PIN wherein the fingerprints of the person entering the PIN are being verified with the help of underlying software application that compares them to the database of stored fingerprints.
